(19) United States
(12) Patent Application Publication
(10) Pub. No.: US 2020/0290640 A1
(43) Pub. Date: Sep. 17, 2020

(54) METHOD FOR CARRYING OUT FULLY AUTOMATIC DRIVING PROCESS OF A MOTOR VEHICLE

(71) Applicant: Audi AG, Ingolstadt (DE)

(72) Inventor: Florian SCHULLER, Ismaning (DE)

(73) Assignee: Audi AG, Ingolstadt (DE)

(21) Appl. No.: 16/650,985

(22) PCT Filed: Sep. 3, 2018
(86) PCT No.: PCT/EP2018/073583

§ 371 Date: Mar. 26, 2020

(30) Foreign Application Priority Data
Oct. 27, 2017 (DE) 10 2017 219 389.1

(51) Int. Cl. B60W 60/00; G07C 5/00; G01C 21/34

(52) U.S. Cl. CPC B60W 60/001; G01C 21/3461; G07C 5/008

(57) ABSTRACT

The present disclosure relates to a method for carrying out a fully automatic driving process of a motor vehicle in an environment equipped with a monitoring system. The method includes locating the motor vehicle in the environment by means of the monitoring system. The method includes checking, based on the location of the motor vehicle, whether the motor vehicle is located in a predetermined area of operation within the environment and then starting and carrying out the fully automatic driving process if the motor vehicle is located in the predetermined area of operation and the existence of a communication link between the motor vehicle and the monitoring system is confirmed.

### TECHNICAL FIELD

The present disclosure relates to a method for carrying out a fully automatic driving process of a motor vehicle in an environment equipped with a monitoring system, and a motor vehicle that is designed to carry out a fully automatic driving process in communication with the monitoring system according to such a method.

### BACKGROUND

Vehicle functions for automated driving of a motor vehicle, as they are currently installed in motor vehicles, can use digital maps to plan the route of the motor vehicle within a specific environment and can move in the specific environment in a sensor-supported manner without collisions. In addition, such autonomously driven vehicles can communicate wirelessly with vehicle-external monitoring devices using Car2X radio technology. However, in the case of fully automatic driving functions, in which a driver is no longer necessarily inside the vehicle, it must be ensured that the motor vehicle only moves autonomously within predetermined, clearly defined spatial boundaries. In the event that this protected environment is left unintentionally, the motor vehicle must be stopped immediately.

From DE 10 2014 221 751 A1, a method for autonomously driving a motor vehicle to a parking lot is known. In this case, a route in the parking lot from a starting position to a target position is determined vehicle-externally, at least one section of the route is transmitted to the motor vehicle, and the motor vehicle is monitored for deviations from the predefined path by a vehicle-external monitoring system when the motor vehicle drives the at least one section of the route autonomously.

From DE 10 2014 221 754 A1, a method for carrying out an automatic parking process of a motor vehicle is known, in which a reservation query for a parking position in a parking lot is transmitted to a parking lot management server via a communication network. Navigation data for autonomous navigation to the reserved parking position are transmitted via said network, and the motor vehicle then navigates autonomously to the reserved parking position on the basis of said navigation data. For this purpose, the driving and parking process of the motor vehicle is monitored by the parking lot management system with an internal infrastructure.

Furthermore, DE 10 2015 208 053 A1 proposes a method for reducing a hazard to and/or by a motor vehicle situated in a parking lot. In this method, a communication link between a motor vehicle in the parking lot and a parking lot management system is checked during an at least partially assisted drive in a parking lot. In the event of a disrupted or absent communication link, multiple measures are initiated in order to reduce potential hazards for and/or by the vehicle, which result from the disrupted or absent communication between the motor vehicle and the parking lot management system.

However, this procedure does not ensure that the motor vehicle moves fully autonomously exclusively within its defined spatial boundaries even in the event of technical defects or undesired external influences on the control software of the motor vehicle or the corresponding management system of the environment, such as a corresponding hacker attack.

### BRIEF DESCRIPTION OF DRAWINGS/FIGURES

FIG. 1 shows a schematic depiction of a parking garage equipped with a monitoring system, in which a motor vehicle in a predetermined area of operation is guided fully automatically along a route from a transfer area to a target area, in accordance with some embodiments.

FIG. 2 shows a schematic depiction of the parking garage, in which the area of operation of the motor vehicle was adjusted due to black ice, in accordance with some embodiments.

FIG. 3 shows a schematic depiction of the parking garage, in which the motor vehicle is located in a peripheral area of the area of operation and could leave the area of operation due to its orientation and positioning with fully automatic guidance, in accordance with some embodiments.

FIG. 4 shows a schematic depiction of method steps for executing the fully automatic driving process of the motor vehicle in the parking garage equipped with the monitoring system, in accordance with some embodiments.

### DETAILED DESCRIPTION

The problem addressed by the present disclosure is that of providing an option, by means of which a particularly safe, fully automatic driving process of a motor vehicle can be made possible in an environment equipped with a monitoring system.

According to the present disclosure, this problem is solved by a method for carrying out a fully automatic driving process of a motor vehicle in an environment equipped with a monitoring system, comprising the steps: locating the motor vehicle in the environment; checking, on the basis of prelocation, whether the motor vehicle is located in a predetermined area of operation within the environment; if the motor vehicle is located in the predetermined area of operation and a communication link between the motor vehicle and the monitoring system exists, starting and carrying out the fully automatic driving process. The method proposed according to the present disclosure is therefore a method, with which a motor vehicle can be driven in an automated manner. This automated driving takes place in a specific delimited spatial area which is equipped with a monitoring system that monitors and controls the sequence of the automated driving. At first, the motor vehicle is positioned in the specific delimited spatial area. This positioning can be achieved by the monitoring system. However, it is also possible that the positioning is carried out exclusively by corresponding vehicle functions of the motor vehicle if, for example, the monitoring system does not have the sensors and/or camera systems required for such purpose. The positioning is used to check whether the motor vehicle is located in a specific sub-area of the spatial area, in which a use of the fully automatic driving function of the motor vehicle at least meets and is permitted by the legal safety requirements for automated driving.

In some embodiments, if the motor vehicle is located in the specific sub-area of the spatial area and the motor vehicle and the monitoring system are also in contact via corresponding interfaces in the vehicle and the monitoring system, it is possible for the automated driving of the motor vehicle to begin and be carried out. As soon as the communication link between the motor vehicle and the monitoring system has been established and it has been ensured that the motor vehicle is within its area of operation, starting and carrying out the fully automatic driving process is thus only made possible, but does not take place immediately.

In some embodiments, the environment equipped with a monitoring system is a specific infrastructure, for example, a structure such as a parking garage or a specific road section. If a motor vehicle is located in the vicinity of such an environment, for example, in a corresponding parking garage, a vehicle function designed for automated driving can establish a communication link to the monitoring system of the parking garage, wherein the monitoring system is part of a management system of the parking garage. This communication link is, for example, a radio communication via Institute of Electrical and Electronics Engineers (IEEE) 802.11p (pWLAN) or Long-Term Evolution for Vehicles (LTE-V). The monitoring system of the parking garage then preferably locates the motor vehicle in the parking garage, for example, based on the digitized maps of the parking garage available to the monitoring system. On the basis of the data of this absolute positioning of the motor vehicle, the monitoring system checks whether the motor vehicle is located in a specific area of operation within the parking garage. This area of operation can be, for example, a specific parking deck or an area of the parking garage approved for automated driving. Once it has been ensured that the motor vehicle is in the predetermined area of operation within the parking garage and that a communication link between the motor vehicle and the monitoring system exists, a corresponding signal is transmitted to the vehicle function provided for fully automatic driving, so that, from this point in time, starting and carrying out the fully automatic driving process is possible, which is, for example, a fully automatic parking process in the parking garage.

In some embodiments, after the fully automatic driving process has been made possible, it is started when a predetermined user action has been recorded. The motor vehicle therefore moves fully automatically with an automated driving function when a specific activation action has been carried out by a user of the motor vehicle. This user action, which can also be referred to as a user/operator request, is, for example, the activation of a corresponding vehicle function of the motor vehicle by pressing a button in the vehicle interior. The automated driving process can therefore be started if it has been ensured that the motor vehicle is located in the predetermined area of operation and a communication link between the motor vehicle and the monitoring system exists, and the fully automatic driving process has also been activated by the user of the motor vehicle. This represents an additional safeguard for the automated driving function because an unauthorized starting of the motor vehicle can be prevented in the event of an error in the control system or if the fully automatic driving function is influenced externally. As a result, it can be prevented that the motor vehicle is moved fully autonomously in an undesirable manner and with an increased safety risk, for example, due to a hacker attack on the control of the vehicle function designed for fully automatic driving.

In some embodiments, the user action is provided such that both a vehicle function designed for a fully autonomous driving process in the vehicle interior and a confirmation unit outside the motor vehicle may be operated. The activation action carried out by the user of the motor vehicle thus consists of two steps, one of which is carried out in the interior of the motor vehicle, and the other one only takes place after the motor vehicle has already been vacated by the user. The user action in the vehicle interior can be, for example, the actuation of a switch of a vehicle function for autonomously driving a motor vehicle. This actuation can be motivated by the user personally or in response to a corresponding query by an operator of the monitoring system of the environment. By way of a non-limiting example, it is possible for the actuation function in the vehicle interior to be carried out by a person commissioned by the operator and not by the user of the motor vehicle. The corresponding query to the operator can be carried out remotely by the user via the communication link, for example, using a corresponding smartphone app. For identifying and authenticating the query, a security token, for example, can be used in the vehicle.

In some embodiments, the confirmation unit to be operated outside the motor vehicle can be, for example, a remote-controlled control via an app on a smartphone, on the user interface of which a button must be pressed, whereupon the fully automatic driving process is triggered. This allows for a clear, thus doubly secured, control by the user of the motor vehicle over the triggering, but also the execution, of the automated driving.

In some embodiments, the starting of the fully automatic driving process is prevented as soon as the communication link is interrupted. By way of a non-limiting example, if a communication link was initially established between the motor vehicle and the monitoring system of the environment of the motor vehicle, and it was checked whether the motor vehicle is located in a predetermined area of operation within the environment, it would basically be possible to start a fully automatic driving process. However, if it is determined that the communication link is no longer available, i.e., the contact between the motor vehicle and the monitoring system of the environment is interrupted, a starting of the fully automatic driving process is blocked. This represents an additional safety mechanism prior to the beginning of the automated driving of the motor vehicle. In some cases, it is possible that, prior to starting the fully automatic driving process, it is additionally checked whether the motor vehicle meets specific conditions, for example, whether all doors and windows are closed, a predetermined tire pressure is set, or whether predetermined conditions of individual vehicle systems, such as the transmission, are met. The checking of these conditions can also continue to be carried out while the fully automatic driving process is executed and used as an additional criterion for terminating the fully automatic driving process. By way of a non-limiting example, it can be provided that a fully automatic driving process is only possible when the motor vehicle is initially at a standstill.

In some embodiments, the fully automatic driving process is terminated if the motor vehicle is located outside the predetermined area of operation and/or the connection to the monitoring system is interrupted. By way of a non-limiting example, if the motor vehicle has left its predetermined area of operation and/or the contact between the motor vehicle and the monitoring system no longer exists, a further execution of the automated driving is prevented. In this case, the motor vehicle can be decelerated, for example, abruptly or along a specific route and then kept at a standstill. This allows for an additional safeguarding of the automated driving in an environment equipped with a monitoring system.

In some embodiments, a route of the motor vehicle intended for the fully automatic driving process is transmitted to the monitoring system via the communication link and checked by the monitoring system with regard to the predetermined area of operation, wherein the starting or execution of the fully automatic driving process is prevented or interrupted when at least a portion of the planned route lies outside the predetermined area of operation. By means of the vehicle function designed for automated driving, the planned route of the motor vehicle is thus transmitted to and checked by the monitoring system with regard to the predetermined area of operation. If at least a section of said planned route lies outside the predetermined area of operation of the motor vehicle, the starting or the execution of the fully automatic driving process is prevented or stopped.

In some embodiments, if the motor vehicle is located, for example, in a parking garage equipped with a corresponding monitoring system, and the monitoring system determines that the route provided by the corresponding vehicle function of the motor vehicle within the parking garage, i.e., the route from a specific starting position to a possible parking position, runs through a partial area of the parking garage that lies outside the predetermined area of operation of the motor vehicle, any fully automatic driving process is prevented. Such an area within the parking garage that is not within the predetermined area of operation can be, for example, an uncovered parking deck covered with black ice or a currently closed level of the parking garage. It is thus possible for a fully automatic driving process to be checked before its actual start in order to determine whether the planned route of the motor vehicle can be released and is consequently safe within the environment.

In some embodiments, the monitoring system of the environment can react to sudden changes in the area of operation. If, for example, an accident takes place on a specific parking deck of the parking garage, the specific parking deck can be defined by the monitoring system as being outside the predetermined area of operation, so that an automated drive previously provided at this parking level is prevented.

In some embodiments, an orientation and a positioning of the motor vehicle in the environment are determined, transmitted to the monitoring system and checked via the monitoring system with regard to the predetermined area of operation, wherein the starting and execution of the fully automatic driving process is prevented or aborted if the motor vehicle is located in a predetermined peripheral area of the area of operation and would leave the predetermined area of operation due to its orientation and positioning when starting or executing the fully automatic driving process. With a corresponding vehicle function, both the orientation and the current location of the motor vehicle within the environment are determined. These data are transmitted to the monitoring system via the existing communication link and, if the motor vehicle is located in a specific outer area of the area of operation, checked by the monitoring system as to what extent the motor vehicle would be located within the predetermined area of operation after the start or during the execution of the fully automatic driving process. If this case can be derived from the orientation and positioning data of the motor vehicle, any start or execution of the automated driving is prevented or stopped. If the motor vehicle is located, for example, at the location of a parking garage, at which the users of the motor vehicle can board or exit the motor vehicle, i.e., at a position located in the peripheral area of the area of operation, and if it can be concluded on the basis of the orientation of the motor vehicle that the motor vehicle would leave the predetermined area of operation when the fully automatic driving function is started, the automated drive is not released. This allows for an additional safeguarding of the fully automatic driving process because it can be ensured that the motor vehicle does not leave its predetermined area of operation.

In some embodiments, the orientation and the positioning of the motor vehicle are determined by corresponding vehicle functions, and the start or execution of the fully automatic driving process is prevented or aborted if the position and/or orientation of the motor vehicle determined by the monitoring system on the basis of prelocation deviates from the position and/or orientation determined by the corresponding vehicle function. The orientation and the position, at which the motor vehicle is located, are thus determined by specific sensor units or other components of the motor vehicle designed for such purpose. In this case, for example, an orientation and positioning of the motor vehicle is possible by taking into account six degrees of freedom, i.e., a 6DoF positioning (six degrees of freedom positioning). The position of the motor vehicle thus determined is compared with the position determined by the monitoring system on the basis of prelocation of the motor vehicle in the environment. If these two position data differ from one another, starting or executing an automated driving of the motor vehicle is prevented or stopped. A deviation of the position data of the motor vehicle and the position data determined by the monitoring system indicates, for example, that there is a defect in the corresponding vehicle function and/or in the monitoring system. This additional comparison of the position data provides a further safeguard for the fully automatic driving process.

In some embodiments, by way of a non-limiting example, the orientation of the motor vehicle determined by the motor vehicle can be compared with the orientation of the motor vehicle determined by the monitoring system and checked for deviations. If these two orientation data deviate from one another, starting or executing an automated driving of the motor vehicle is prevented or stopped. Deviations in the orientation data also indicate defects in the corresponding vehicle function and/or in the monitoring system, so that a comparison of the orientation data allows for a further safeguarding of the fully automatic driving process.

In some embodiments, the communication link between the motor vehicle and the monitoring system is secured. Communication via radio technology, such as pWLAN or LTE-V, is therefore encrypted and takes place via a certified local connection. For this purpose, for example, a three-way handshake method between the vehicle and the monitoring system of the environment or a back-end connection with the vehicle manufacturer or an operator of the environment, for example, an operator of a parking garage with a corresponding monitoring system or a central management facility for several corresponding parking garages, would be possible. The communication between the motor vehicle and the monitoring system is thus secured such that there can be no accidental connection between the motor vehicle and the monitoring system, for example, due to external influences. While the communication link exists, it is also continuously checked whether said connection is certified. If the communication link is renewed after a connection disruption, the newly established connection is also checked with regard to its encryption and certification.

In some embodiments, a motor vehicle is provided which is designed to carry out a fully automatic driving process in communication with a monitoring system in a predetermined environment in accordance with the method as described herein according to various embodiments. The motor vehicle is thus able to allow automated driving to take place in accordance with the described embodiments. However, this requires that a communication link with the monitoring system has been established beforehand. The monitoring system of a corresponding environment may therefore be designed to be able to carry out a method according to the described embodiments. Both the motor vehicle and the monitoring system may therefore have corresponding communication interfaces and corresponding sensor and monitoring components.

The embodiments described below are preferred embodiments of the present disclosure. In the embodiments, the described components of the embodiments each constitute individual features of the present disclosure to be considered independently of one another and in a combination different from the combination described. In addition, the embodiments described can also be supplemented by further features of the present disclosure, which have already been described.

In the drawings, functionally identical elements are each denoted with the same reference signs.

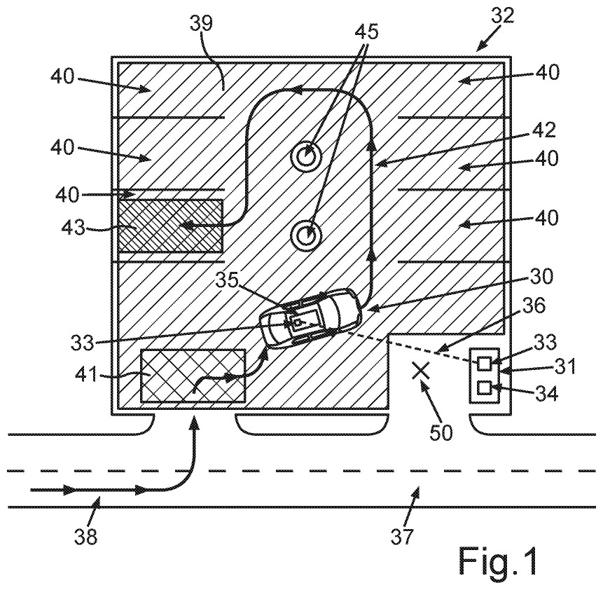

FIG. 1 shows a schematic depiction of a parking garage equipped with a monitoring system, in which a motor vehicle in a predetermined area of operation is guided fully automatically along a route from a transfer area to a target area, in accordance with some embodiments. FIG. 1 shows a parking garage 32 with a monitoring system 31, in which a fully automatic driving process of a motor vehicle 30 takes place. The parking garage 32 has a total of six parking spaces 40 and two pillars 45, and the monitoring system 31 has a communication interface 33 and an evaluation device 34. The motor vehicle 30 is equipped with a vehicle function designed for fully automatic driving, and a corresponding control device 35 of the vehicle function also has a communication interface 33. When the motor vehicle 30 approaches the parking garage 32, a communication link 36 is established between the communication interfaces 33 of the motor vehicle and the monitoring system 31 of the parking garage 32 by triggering the corresponding vehicle function. This establishing of the connection can already take place at a specific distance from the parking garage 32. For example, if parking in the parking garage 32 is planned, which can be set, for example, using corresponding settings in a navigation system of the motor vehicle 30, the communication link 33 between the motor vehicle 30 and the monitoring system 31 can be established some time before the arrival of the motor vehicle 30 at the parking garage 32, for example, while the motor vehicle 30 is located outside the parking garage 32 on a road 37 and travels along an approach route 38 to the parking garage 32.

In accordance with some embodiments, as soon as it has been determined that the communication link 36 between the motor vehicle 30 and the monitoring system 31 exists and the motor vehicle 30 has reached the parking garage 32, the motor vehicle 30 is prelocated in the parking garage 32 by the monitoring system 31 using digital maps of the parking garage 32. The monitoring system 31 subsequently checks whether the motor vehicle 30 is located within a predetermined area of operation 39 within the parking garage 32. The predetermined area of operation 39 is, for example, specific parking decks of the parking garage 32, on which specific parking spaces 40 are reserved for fully automatically parking motor vehicles 30. If it is determined that the motor vehicle 30 is located within its predetermined area of operation 39, and it can be confirmed that the communication link 36 continues to exist, the fully automatic driving process is made possible.

It is now possible for the fully automatic driving process to be started by a corresponding user action. During a subsequent fully automatic driving process along a route 42 to a target area 43 in the parking garage 32, it is further checked whether the communication link 36 between the motor vehicle 30 and the monitoring system 31 exists, and whether the motor vehicle 30 is still located within its predetermined the area of operation 39. If the communication link 36 is interrupted, for example, due to a malfunctioning of the radio link or due to other technical defects, or if it is observed that the motor vehicle 30 is leaving its predetermined area of operation 39, for example, due to a faulty execution of the automated driving, the fully automatic driving process is terminated. However, during the fully automatic driving process, it is also possible for the fully automatic vehicle function to be terminated in a regular manner, for example, by a corresponding user action or upon the instruction of an operator of the monitoring system 31 of the parking garage 32 requested by the user.

In accordance with some embodiments, for safety reasons, the user actions, with which the fully automatic driving process is started and ended, are preferably double user actions. This double user action consists of an actuation of the motor vehicle 30 by the user inside the motor vehicle 30, for example, by pressing a button on a corresponding vehicle component, and also of a second user action outside the motor vehicle 30, for example, in which a button is pressed on a corresponding app of a smartphone provided for controlling a fully automatic driving process of a motor vehicle 30. The transfer of control of the motor vehicle 30 from the user to the vehicle function designed for a fully automatic driving process takes place in a transfer area 41 which is usually located at the entrance to the parking garage 32 and thus at the edge of the area of operation 39. The user parks the motor vehicle 30 in said transfer area 41, activates the first user action in the vehicle interior, subsequently vacates the motor vehicle 30 and starts the fully automatic driving process along the route 42 to the target position 43 of the motor vehicle 30 by means of the corresponding second user action. In the case of a fully automatic exiting process of the motor vehicle 30 from the target area 43, the user once again receives the motor vehicle in the transfer area 41.

In accordance with some embodiments, if it is determined that the motor vehicle 30 is not located in the predetermined area of operation 39 and/or the communication link 36 between the communication interfaces 33 of the motor vehicle 30 and the monitoring system 31 is interrupted, the fully automatic driving process is prevented. This state is possible, for example, if the motor vehicle 30 has been parked by the user outside the parking garage 32 or at a location within the parking garage 32 that has not been released for such purpose, for example, at the location marked with a cross 50, or if there are malfunctions in the communication link 36 between the motor vehicle 30 and the monitoring system 31, or defects occur in the corresponding communication interfaces 33. However, if the communication link 36 between the corresponding communication interfaces 33 can be reestablished and/or the motor vehicle 30 is again located within the area of operation 39, for example, due to a reparking of the motor vehicle 30 by the driver, the fully automatic driving process is made possible again.

In accordance with some embodiments, before the motor vehicle 30 moves fully automatically in the parking garage 32, i.e., if it is still in the transfer area 41, the route 42 of the motor vehicle 32 is first determined from the transfer area 41 at the entrance of the parking garage 32 to the target area 43 which, for example, is a specific parking space 40 in the parking garage 32. For determining the route, data provided by the monitoring system 31 for parking space occupancy and for orientation in the parking garage 32, for example, digital maps, can also be provided. As soon as the route has been determined, it is transmitted to the monitoring system 31 via the communication link 36. The evaluation device 34 subsequently checks whether this route 42 runs within the area of operation 39 of the motor vehicle 30. If it is determined that the route 42 runs within the area of operation 39, that the motor vehicle 30 is located within the area of operation 39, and that the communication link 36 between the motor vehicle 30 and the monitoring system 31 also exists, the fully automatic driving process is enabled, followed by the steps already described.

If the route 42 runs within the area of operation 39, but the communication link 36 between the communication interfaces 33 of the motor vehicle 30 and the monitoring system 31 is interrupted and/or it is determined that the motor vehicle 30 is located outside the area of operation 39, the fully automatic driving operation is prevented.

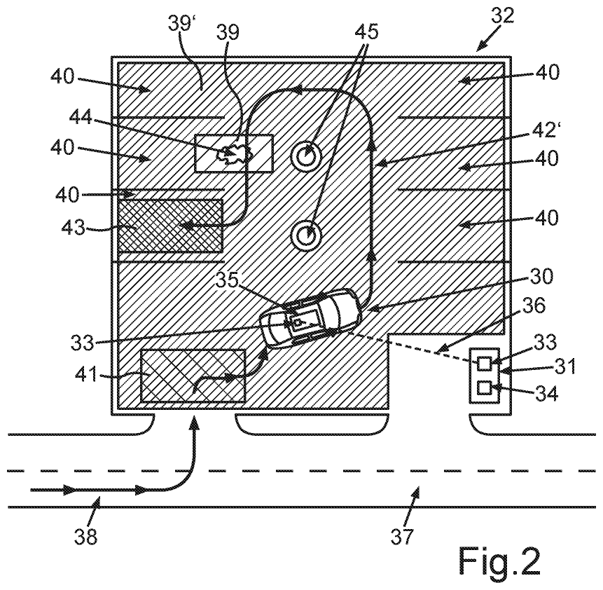

If it is determined during the fully automatic driving process that the predetermined route 42 runs outside of the predetermined area of operation 39, the fully automatic driving process is also terminated. FIG. 2 shows a schematic depiction of the parking garage, in which the area of operation of the motor vehicle was adjusted due to black ice, in accordance with some embodiments. This situation is outlined in FIG. 2 using the route 42′ and would be conceivable if, for example, the area of operation 39 is suddenly changed by the monitoring system 31.

In accordance with some embodiments, if it is determined that a safe driving in a specific area and/or on a specific parking deck of the parking garage 32 is no longer possible. This would be the case, for example, if black ice 44 is registered in an area on an uncovered parking deck or if the lighting conditions on a parking level deteriorate due to malfunctioning lamps. The data necessary for this assessment are provided by the monitoring system 31 which permanently monitors the environmental conditions within the environment, i.e., within the parking garage 32. For this purpose, data, for example, data about the lighting/visibility conditions within the parking garage 32, the friction value on the floor of the parking garage 32 and/or temperature data, can be obtained with different sensor devices or cameras. The friction values can be used to identify, for example, slippery or other sections of the parking garage 32 that cannot be used safely, for example, due to oil stains on the floor of the parking garage. If the operating conditions, for example, a specific minimum brightness or a predefined friction value range, which are predefined for the monitoring system 31, are not met by the prevailing environmental conditions, the affected area of the environment can be defined as lying outside the area of operation 39, i.e., a reduced area of operation 39′ without the affected areas of the environment can be defined. As a result, the motor vehicle 30 is only authorized to drive fully automatically in the area of operation 39′. If the motor vehicle 30 is located outside of the area of operation 39′, the fully automatic driving function is terminated immediately, i.e., the driving authorization for automated driving of the motor vehicle 30 is revoked.

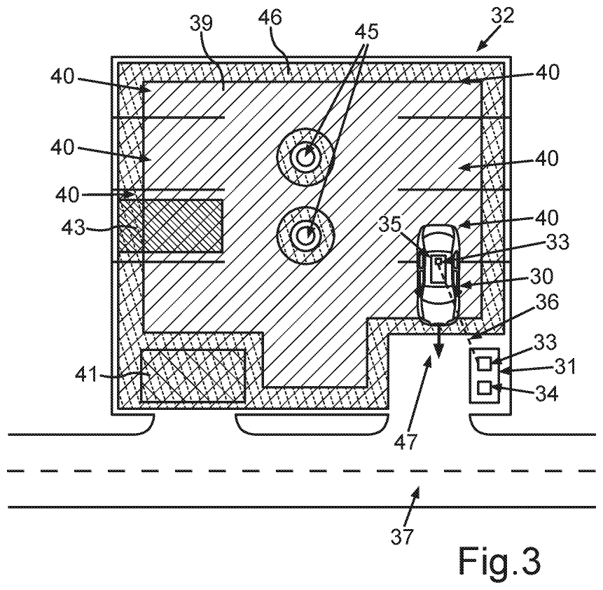

FIG. 3 shows a schematic depiction of the parking garage, in which the motor vehicle is located in a peripheral area of the area of operation and could leave the area of operation due to its orientation and positioning with fully automatic guidance, in accordance with some embodiments. A further additional safeguarding step is outlined in FIG. 3, for which orientation and positioning of the motor vehicle 30 is taken into account by onboard sensors and measuring units within the parking garage 32. First, the orientation and positioning of the motor vehicle 30 is determined by corresponding vehicle components. For example, for this purpose, the proper motion of the motor vehicle 30 can be detected with a corresponding sensor device. In addition, specific features of the parking garage 32, for example, pillars 45, lane markings or corresponding landmarks attached to the parking garage walls for orientation, which are, for example, 2D barcodes, can be detected using external cameras of the motor vehicle 30, so that, by means of the digital map of the parking garage 32 provided by the monitoring system 31, an additional positioning and thus a locating of the motor vehicle 30 in the environment is possible by the motor vehicle 30 itself. The digital map of the parking garage 32 does not necessarily have to be provided by the monitoring system 31. It is also possible that the corresponding vehicle function of the motor vehicle 30 already has a digital map of the parking garage 32, which is only checked by the monitoring system 31 with regard to specific features, such as specific landmarks or the boundaries of the area of operation 39. Prior to their use, the digital maps present in the motor vehicle 30 are thus checked and certified by the monitoring system 31 in the course of the fully automatic driving process.

The orientation and positioning data determined by the motor vehicle 30 are subsequently transmitted to the monitoring system 31 via the communication link 36. Consequently, the evaluation device 34 of the monitoring system 31 checks as to what extent it would be possible that the motor vehicle 30, if it is located in a predetermined edge area 46 of the area of operation 39 and due to its orientation and positioning, could move in the course of the fully automatic driving process such that it would leave the predetermined area of operations 39. A motor vehicle 30 with such an orientation and positioning in the edge area 46 of the area of operation 39 is outlined in FIG. 3, wherein the orientation of the motor vehicle 30 is indicated by an arrow 47.

The orientation and positioning determination, the transmission of these data, and the described checking of the orientation and positioning of the motor vehicle 30 take place continuously. Status data are therefore continuously transmitted from the motor vehicle 30 to the monitoring system 31, which, in addition to the orientation and the positioning of the motor vehicle 30, can also contain further data, for example, the speed of the motor vehicle 30. If the motor vehicle 30 is located in the edge area 46 of the area of operation 39, for example, in the immediate vicinity of the transfer area 41, at which it is provided that the user of the motor vehicle 30 can safely get in and out, the fully automatic driving process is prevented if it is determined that, due to the orientation of the motor vehicle 30, it is possible for the motor vehicle 30 to leave its predetermined area of operation 39 during the fully automatic driving process.

In order to determine whether the complete driving process is to be prevented, the communication link 36 between the motor vehicle 30 and the monitoring system 31 is also checked, and it is ensured that the motor vehicle 30 is located within its predetermined area of operation 39. Even during the fully automatic driving process, when the motor vehicle 30 is located within the predetermined peripheral area 46 of the area of operation 39, it is further checked whether the orientation and positioning of the motor vehicle 30 could result in possible conflicts with its predetermined area of operation 39, and, if necessary, the fully automatic driving process is terminated. The predetermined edge area 46 of the area of operation 39 is typically a relatively small area of the area of operation 39 directly on the edge thereof.

In addition, a position comparison can take place, in which the position data of the motor vehicle 30 determined during the orientation and position determination are compared with the corresponding positioning data of the monitoring system 31 on the basis of prelocation. If deviations between the two positioning data are detected, the fully automatic driving process can be prevented or interrupted. Such a deviation between the two positioning data indicates that there is a defect in a corresponding vehicle function or in a corresponding function of the monitoring system 31, so that the fully automatic driving process is prevented or interrupted for safety reasons.

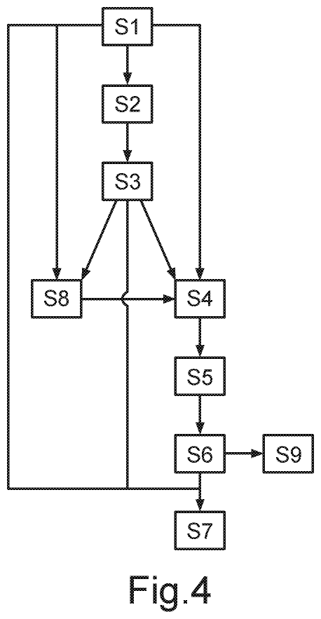

FIG. 4 shows a schematic depiction of method steps for executing the fully automatic driving process of the motor vehicle in the parking garage equipped with the monitoring system, in accordance with some embodiments. In FIG. 4, the individual method steps for carrying out the fully automatic driving process of the motor vehicle 30 in the parking garage 32 equipped with a monitoring system 31 are outlined. The arrows shown in the drawing represent transmitted data or signals.

As soon as the existence 51 of the communication link 36 between the motor vehicle 30 and the monitoring system 31 has been determined and the motor vehicle 30 has reached the parking garage 32, the motor vehicle 30 is located in the parking garage 32 by the monitoring system 31 on the basis of prelocation S2. The monitoring system 31 subsequently checks S3 as to whether the motor vehicle 30 is located within its predetermined area of operation 39 within the parking garage 32. If it is determined that the motor vehicle 30 is located within the area of operation 39 and it can be confirmed that the communication link 36 still exists, the fully automatic driving process is enabled S4.

From now on, a starting S5 of the fully automatic driving process by an appropriate user action is possible. During a subsequent carrying out S6 of the fully automatic driving process, it is further checked whether the communication link 36 between the motor vehicle 30 and the monitoring system 31 exists, and whether the motor vehicle 30 is still within its predetermined area of operation 39. If the communication link 36 is interrupted or it is observed that the motor vehicle 30 is leaving its predetermined area of operation 39, the fully automatic driving process is terminated S7. However, while the fully automatic driving function is carried out S6, it is also possible for the fully automatic vehicle function to be terminated in a regular manner S9.

If it is determined during the check S3, whether the motor vehicle 30 is located in a predetermined area of operation 39, that the motor vehicle 30 is not within the area of operation 39, and/or it is already determined at this point that the communication link 36 between the communication interfaces 33 of the motor vehicle 30 and the monitoring system 31 is interrupted, the starting S5 of the fully automatic driving operation is prevented S8. However, if the communication link 36 between the corresponding communication interfaces 33 can be reestablished and/or the motor vehicle 30 is located again within the area of operation 39, the prevention S8 of the starting S5 of the fully automatic driving process can be withdrawn and the fully automatic driving process can be enabled S4.

Overall, the examples show how the present disclosure allows for a safe method for carrying out a fully automatic driving operation of a motor vehicle 30 in a parking garage 32 equipped with a monitoring system 31. Instead of in a parking garage 32, the method can also be used in another environment equipped with a monitoring system 31, in which a motor vehicle 30 is supposed to be guided fully automatically, for example, on a corresponding section of a highway.

1.-10. (canceled)

11. A method for carrying out a fully automatic driving process of a motor vehicle in an environment equipped with a monitoring system, the method comprising:
locating the motor vehicle in the environment equipped with the monitoring system;
checking, based on the location of the motor vehicle, whether the motor vehicle is located in a predetermined area of operation within the environment;
determining whether a communication link exists between the motor vehicle and the monitoring system; and
in response to the motor vehicle being located in the predetermined area of the operation and in response to the determination that the communication link exists, enabling the fully automatic driving process.

12. The method of claim 11, further comprising in response to detection of a predetermined action, starting the fully automatic driving process.

13. The method of claim 12, further comprising receiving the predetermined action using a vehicle function designed for the fully automatic driving process in interior of the motor vehicle or a confirmation unit outside the motor vehicle.

14. The method of claim 11, further comprising in response to detection of the communication link being interrupted, preventing the fully automatic driving process from staring.

15. The method of claim 11, further comprising terminating the fully automatic driving process upon determining the motor vehicle is located outside the predetermined area of operation or the communication link with the monitoring system is interrupted.

16. The method of claim 11, further comprising:
transmitting, to the monitoring system via the communication link, a route of the motor vehicle intended for the fully automatic driving process, wherein the route is checked by the monitoring system with regard to the predetermined area of operation; and
preventing the fully automatic driving process from starting or executing when at least a portion of the route lies outside the predetermined area of operation.

17. The method of claim 11, further comprising:
determining an orientation and a positioning of the motor vehicle in the environment;
transmitting the orientation and the positioning of the motor vehicle to the monitoring system for checking with regard to the predetermined area of operation; and
preventing the fully automatic driving process from starting or executing upon determination that the motor vehicle is located in a predetermined peripheral area of the predetermined area of operation, or upon determination that the motor vehicle would leave the predetermined area of operation based on the determined orientation and positioning of the motor vehicle.

18. The method of claim 17, further comprising:
determining the orientation and the positioning of the motor vehicle using corresponding vehicle functions; and
preventing the fully automatic driving process from starting or executing when the positioning and/or orientation of the motor vehicle determined by the monitoring system based on the location of the motor vehicle deviates from the positioning and/or orientation determined by the corresponding vehicle functions.

19. The method of claim 11, further comprising establishing the communication link between the motor vehicle and the monitoring system as a secure communication link.

20. A motor vehicle, comprising:
a control system configured to perform operations to carry out a fully automatic driving process of the motor vehicle in an environment equipped with a monitoring system, wherein the operations comprise:
locating the motor vehicle in the environment equipped with the monitoring system;
checking, based on the location of the motor vehicle, whether the motor vehicle is located in a predetermined area of operation within the environment;
determining whether a communication link exists between the motor vehicle and the monitoring system; and
in response to the motor vehicle being located in the predetermined area of the operation and in response to the determination that the communication link exists, enabling the fully automatic driving process to start the fully automatic driving process.
